(19) United States
(12) Patent Application Publication
(10) Pub. No.: US 2008/0084040 A1
(43) Pub. Date: Apr. 10, 2008

(54) Conditioned-air baby stroller

(76) Inventor: Richard McGowan, Philadelphia, PA (US)

Correspondence Address: Richard McGowan JR, 6229 North 17th St, Philadelphia, PA, 19141, US

(21) Appl. No.: 11/543,288

(22) Filed: Oct. 4, 2006

(51) Int. Cl. B62B 7/00

(52) U.S. Cl. 280/47.38

(57) ABSTRACT

Keeping an infant comfortable and well ventilated when out for a stroll with mommy is the intent of this invention. A conditioned-air baby stroller keeps an infant comfortable while pushed by its caretaker. The working components of the heating and cooling apparatus are easily attachable by Velcro® or other attachment means to the baby carriage. Reliable electrical power is assured by a small electrical generator mechanically rotated when the childcare provider pushes the four-wheeled carriage. The generator provides heated or cooled air for the baby's comfort, electrically powering fan assemblies, easily mounted inside the canopy in a flow direction desired by the caretaker. Each fan assembly comprises a housing, a blower fan and motor, and heating element disposed in the housing and protected from accidental contact by a protective screen. An optional battery, kept charged by the electrical generator, continues to provide electric power if the caretaker stops the carriage. By applying electrical power from the generator to the heating element the infant is kept warm in cold weather. In hot weather the air intake side of each fan housing allows insertion of a refrigerated cold pack for increased infant comfort. Desired heating and cooling conditions are selected by activation of selection buttons fixedly securable by a clamp mechanism is to the handle of the baby stroller. An optional snap-on cover provides a microenvironment for the infant in times of temperature extremes.

### CROSS-REFERENCE TO RELATED APPLICATION

Not applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

1. Field of the Invention

The present invention relates to baby strollers and more particularly to conditioned-air baby strollers, generally classified under classification 280/650 and 280/658 of the U.S. Patent classification system for baby carriages. In particular the present invention pertains to air circulated by fans operating heating and cooling sources while the caretaker pushes the carriage providing self-generated electrical power. Thereby conditioned air in the interior of a baby carriage helps keep an infant well ventilated and comfortable.

2. Description of the Prior Art

The use of baby carriages and strollers is known in the prior art. Baby carriages and strollers heretofore devised and utilized are known to consist basically of familiar, expected, and obvious structural configurations. Myriad designs have been developed for the fulfillment of countless objectives and requirements. More specifically, baby carriages and cooling devices of known means and configurations heretofore devised and utilized are known to consist basically of familiar and obvious structural configurations. Known prior art includes, for example:
U.S. Pat. No. 2,646,843 by Adler provides a protective cover for baby carriage contents.
U.S. Pat. No. 3,963,382 by Patton provides a portable circulating fan protected by a wire cage.
U.S. Pat. No. 3,191,958 by Smith provides an adjustable canopy for a baby carriage.
U.S. Pat. No. 3,776,217 by Galen et. al., provides a blower for a dust-free nursing box.
U.S. Pat. No. 4,839,106 to Steiner, Jun. 13, 1989 discloses a portable misting fan.
U.S. Pat. No. 5,338,495 to Steiner et & el., issued Aug. 16, 1994 loses a portable misting fan.
U.S. Pat. No. 5,349,975 by Steiner provides a portable fan with mister for sunbathers.
U.S. Pat. No. 5,725,356 to Carter providing a portable battery powered fan for a baby stroller.
U.S. Pat. No. 6,012,756, by Karen Clark-Dickson discloses a mesh type UV baby carriage cover.
U.S. Pat. No. 6,027,137 to Joan Rura provides a vertically disposed fan with cold pack without disclosing the electrical source, for cooling a baby in a baby carriage.
U.S. Pat. No. 6,127,655 to Linda and William Humes provide an electrically heated pad the length of a baby for a baby carriage.
U.S. Pat. No. 6,409,206 to Willrich provides a permanently attached fan assembly powered by a battery to provide moving air to cool an infant in a baby carriage.
U.S. Pat. No. 6,979,018 to Kassai, et. al, provides moveable apertures to control the degree of ventilation for a baby carriage.
U.S. Pat. No. 6,992,588 to Santosstefano provides an attachable alarm system for avoiding baby abduction.
U.S. Pat. No. 7,000,625 to Dickson providing a mesh sun screen attachment for a baby stroller to

While the patents reviewed above fulfill their respective requirements they are generally limited by battery powered operation, especially since batteries often fail at most inconvenient and inauspicious times. In addition, the apparatus required for an infant's comfort is generally not attachable when weather conditions require them or detachable when weather conditions do not require them. For example, a heated seat, described in prior art, consisting of heating elements surrounded by an insulating layer and formed in such a manner that the padding and the insulating layer are enveloped by a sheath distributed along its entire seating area such that a child placed in such a seat receives electrical heating, requires a substantial heating element requiring too much electrical power to be practical using a battery. The aforementioned patents, also, do not disclose an electric generator mechanically powered for improved reliability, especially of an attachable/detachable nature for conditioned air baby stroller apparatus. In view of the foregoing disadvantages inherent in the known types of air conditioned baby carriages and, strollers now present in the art, the present invention relies on innovations utilizing reliable circulating conditioned air in the interior of a baby carriage for keeping an infant therein well ventilated and comfortable.

An infant is helpless to provide for its own comfort in a stroller. Pushed by its caretaker in hot or cold weather the baby is subjected to extremes in temperature. The demand for heated strollers is quite acute in cold climates whereas cooling is required in geographical locations of high temperature. Thus severe climate temperatures or seasonal variations of temperature in the temperate zones provide ample reason to control the infant's microenvironment.

It can be appreciated that there exists a continuing need for new and improved baby carriages which can provide both heated and cooled conditioned air for an infant within an enclosed or partially enclosed carriage for the infants increased comfort. A reliable non-battery powered energy supply is also highly desirable. By these requirements the present invention substantially fulfills this need.

Generally, battery sources are proscribed in state of the art baby strollers for providing the electrical power required for heating and cooling. Usually a compartment is formed, positioned remotely from the child, and adapted for receiving a battery pack. A charging socket electrically connected to the battery power source is usually provided for recharging from an outside source of electrical energy. The trouble with these designs is the necessity of provide a reliable source of electrical energy for an infants comfort from batteries notoriously losing power at ill-timed occasions.

The present invention allows the caretaker to provide for the infants comfort at the push of a button. A fan recirculates air inside the stroller providing cooling air or warmed air by use of a small heater. Rather than relying on batteries which might be discharged at an inauspicious time, it is the movement of the stroller itself mechanically turning a small generator that provides the electricity to operate the fan and heater thereby assuring that operation of the conditioned air apparatus is always functional. By another embodiment of the invention a battery may also be provided wherein the electrical generator recharges the battery pack, thereby assuring electrical energy even when the carriage is not pushed. As to a further embodiment of the invention, a thermal switch may operably be connected to the power arrangement providing effective on or off switching of the electrical power source in response to the temperature within the child receiving area of the baby carriage. When the temperature is below a predetermined level the power source is switched on activating a small heater within the child receiving area. When the temperature is above a predetermined level the power source activates cooling of the air temperature within the child receiving area.

The electrical heating element can be formed as a single heating wire arranged in a serpentine manner or formed as a plurality of electrical heating wires arranged in another functional manner. According to still another embodiment of the invention, a connection cable electrically connects the electrical heating element and the respective fan motors for delivery of the electric power required for operation from the generator.

The fan and heater are affixed to the inside of the canopy of the stroller, carriage or bassinet via fabric ties, Velcro® fasteners, elastic hooks, snaps, or loops well out of the way, thereby avoiding the possibility the infant being harmed.

### BRIEF SUMMARY OF THE INVENTION

The general purpose of the present invention, which will be described subsequently in greater detail, is to provide conditioned air for a baby within a stroller, having novel features not anticipated or rendered obvious by prior art. There has been outlined, rather broadly, the more important features of the invention in order that the detailed description that follows may be better understood, and in order that the present contribution to the art may be better appreciated. Additional features of the invention will be described hereinafter and will form the subject matter of the claims appended hereto.

The baby carriage canopy has inside side portions which each have a fan assembly mounted thereto. Each fan assembly comprises a housing, a blower fan with motor, and a heater disposed in the housing. Each self-contained fan assembly is conveniently attached to the inside surface of the canopy as by Velcro®, positioned as desired by the caretaker, and attached thereto so that the infant receives the benefit of the conditioned air without undue direct air flow. The air input face of the fan assembly has an inlet opening therein facing toward the inside face of the canopy but allowing air intake.

In these respects, the attachable fan cooled or warmed air according to the present invention substantially departs from the conventional concepts and designs of the prior art wherein the fans are fixed in position at construction of the baby stroller. By the present invention the components of the conditioned air apparatus are entirely detatchable via fabric ties, Velcro® fasteners, elastic hooks, snaps, or loops allowing storage when temperature conditions are favorable for use of the baby carriage without the need for conditioned air, or for their use when adverse temperature conditions warrant.

At assembly the fan assemblies are first affixed to the inside of the canopy of the stroller, the control module is clamped to the push handle, then the electrical generator hub is placed in contact with a carriage wheel. Consequently, by merely pushing buttons it become easy to provide circulated conditioned air to the interior of a baby carriage keeping an infant therein well ventilated and comfortable during a stroll.

It is therefore an object of the present invention to provide a conditioned air baby stroller apparatus and method having many of the advantages of the baby carriages and strollers mentioned heretofore with novel features not anticipated, rendered obvious, suggested, or even implied by any of the prior art baby carriages and strollers, either alone or in any combination thereof.

It is another object of the present invention to provide a conditioned air baby stroller using components easily attachable or detatchable as outside temperature conditions require.

It is a further object of the present invention to provide a conditioned air baby stroller powered by the caretaker who mechanically rotates an electrical generator thereby providing reliable operating power for the conditioned air apparatus.

It is a further object of the present invention to provide a conditioned air baby stroller powered by an electrical generator for recharging a battery for operation when the baby carriage is not being pushed.

It is a further object of the present invention to provide a conditioned air baby stroller, which may be easily and efficiently manufactured and marketed.

It is a further object of the present invention to provide a new fan cooled baby stroller which is of durable and reliable construction.

An even further object of the present invention is to provide a fan cooled baby stroller which is susceptible of a low cost of manufacture with regard to both materials and labor which accordingly provides low cost acceptance.

### BRIEF DESCRIPTION OF THE DRAWINGS

The invention will be better understood and objects other than those set forth above will become apparent when consideration is given to the following detailed description thereof. Such description nukes reference to the annexed drawings wherein:

FIG. 1 is a perspective view of the exterior of the conditioned air baby stroller according to the present invention.

FIG. 2 is a perspective view of the apparatus and components of the present invention including a schematic electrical diagram of the electrical connections.

### DESCRIPTION OF THE PREFERRED EMBODIMENT

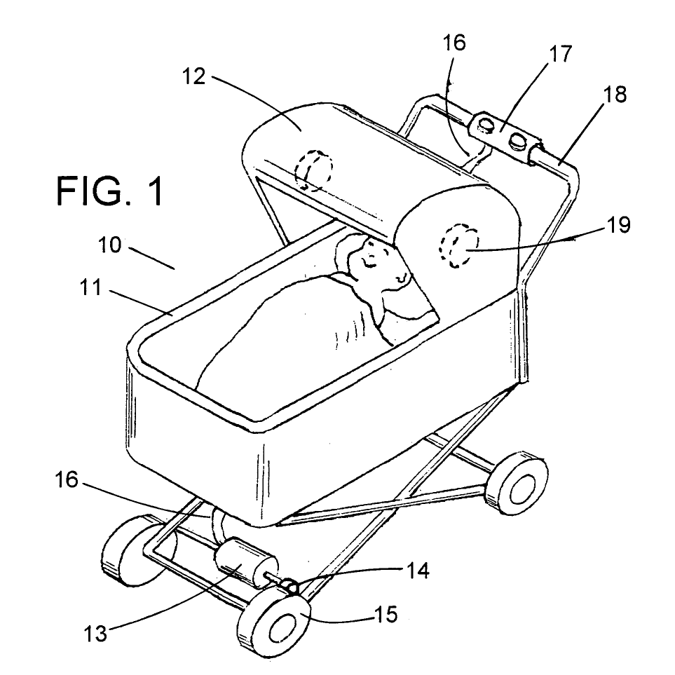

With reference now to the drawings and in particular to FIG. 1, a conditioned air baby stroller embodying the principles and concepts of the present invention and generally designated by the reference numeral 10 will be described.

As best illustrated in FIG. 1, conditioned air apparatus is affixed to respective portions of a baby stroller 10, as by use of Velcro® fastening or equivalent, generally comprising the following components; a small electrical generator 13 affixed near a wheel of the baby stroller 10, a push button control 17 affixed to the carriage push handle 18, and electrically connected to fan assemblies 19 affixed to the interior of canopy 12. Activation of buttons on push button control 17 electrically activates cooling or heated air adjacent the infant.

A canopy 12 is generally mounted over the bassinet 11. Sometimes an added cover (not shown) of transparent material is fastened to the bassinet and canopy for providing a microenvironment to further isolate conditioned air for the infant. The canopy 12 has side portions to which a fan assembly 19 as shown is mounted on the interior surface. Each side of canopy 12 generally has a fan assembly 19 comprises a housing, a blower fan 21 with motor, and heating element 20 disposed in the housing. The fan assembly housing is attached using Velcro® or similar attachment method to the interior of the canopy where desired when extremes in temperature warrant providing for the infants comfort. Fan 21 blows air into the interior of the canopy for cooling or when heating elements 20 are activated warmed air is provided. The back face of each of the fan housings has an electrical wiring access.

In closer detail, the baby carriage 10 comprises a bassinet 11 for resting an infant therein. Typically the baby carriage has a bedding pad for resting an infant thereon as illustrated in FIG. 1. The bassinet further includes a ground engaging wheel assembly for supporting the bassinet above a ground surface and including a carriage wheel such as 15. To the wheel assembly small electrical generator 13 is attached allowing generator hub to be turned by wheel 15 providing the electrical energy required to power the apparatus.

Canopy 12 is mounted to the bassinet 11 over the open top of the bassinet and as shown in FIG. 1 the front portion of the canopy is normally positioned so that the infant can see ahead. The side portions of the campy are positioned adjacent each side of the baby's head therefore the fan assemblies 19 might be positioned near the interior center portion each side providing a convenient attachment surface. Wherever the fan assemblies are attached it is the infants comfort that is the main concern.

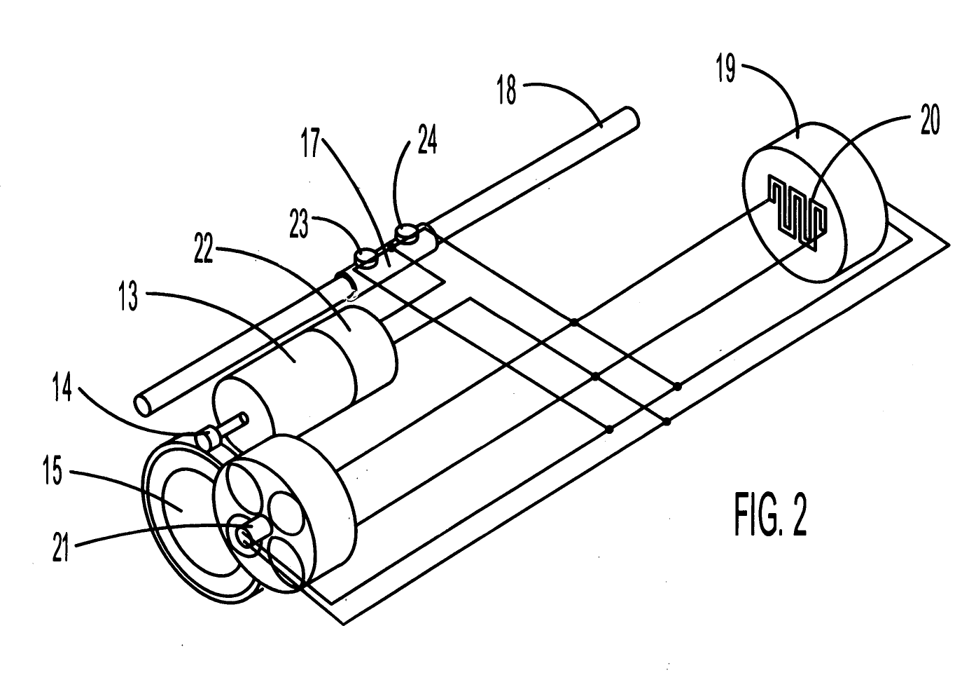

FIG. 2 shows the components of the attachable conditioned air apparatus showing fan assemblies 19 comprising a housing, a heating element 20, and a blower fan with motor 21 which rotates the blower fan disposed in the housing. The housings of the fan assemblies are conveniently mounted by use of Velcro® or equivalent fastening method to the inside of the canopy 12 as shown in FIG. 1. The air exit face of each fan assembly 19 faces inwards into the canopy from the associated side portion of the canopy. The outer side face of each housing faces the inside of the canopy but are designed to permit air intake this side. Preferably, each of the housings has a screen mesh substantially covering the air exit face (not shown) protecting the baby and preventing objects greater than a predetermined size from passing through the outlet openings. The screen additionally assures protection against injury from the fan when rotating although the fan is located at the back of the housing.

Generally the fan assemblies are designed for low electrical power requirement as provided by the small electrical generator 13 whereby air is blown out the fan housing only inside the canopy and not outside of the canopy. Fan 21 is driven by its associated fan motor mounted on a drive shaft secured within the housing by electricity supplied by generator 13. Voltage regulator 22 of electrical generator 13 provides for proper voltage variation control.

Battery power sources are generally disclosed in state of the art apparatus. This type electrical power source is unreliable. Since the caretaker is pushing the baby carriage anyway, electrical generator 13 with associated voltage regulator 22 permits a reliable source of energy to thereby exclude reliance on batteries, solar cells, or other not always reliable electrical power sources. Thus the act of pushing the infant in the baby stroller permits both traversing the ground surface and conveniently provides the energy required to electrically operate the conditioned air apparatus.

Push handle 18 extending from the back of the bassinet conventionally permits the caretaker to push the bassinet across the ground surface while providing a convenient place to snap-attach electrical push button control 17. Thus a reliable source of electrical energy conveniently controlled by push button control 17 allows convenient electrical connection of the motors of the fan assemblies by pushing latch and break button 23 whereas latch and break button 24 activates both the fan and heating elements.

For cooling requirements in extra warm weather a pouch for holding a refrigerated cold pack (not shown) adapted to be cooled at a remote location may be added whereby a cover flap with fastener permits opening the cover flap to insert the cold pack before the fan. This permits cooling in addition to the moving fan air alone. Absorption of moisture from the cold pack may also be provided. When the on/off switch is energized to activate the fan added circulation of cool air onto an infant within the canopy of the carriage is provided by this method.

The electrical control switch actuator is preferably mounted on the push handle of the carriage to conveniently allow the caretaker user to push the baby carriage with the push handle while selectively pressing buttons on push button control 17 to allow either moving air, cooled air, or warned air. The general arrangement of the conditioned air components and the electrical schematic shown in FIG. 2 allows energizing the fan motor and/or both the fan 21 and heating element 20. Hub 14 of generator 13, pressed against wheel 15 provides the mechanical power when baby stroller 10 is pushed to rotate electrical generator 13 thereby providing the electrical power. Pressing latch and break button 23 engages the circuit electrically connecting to the motors of the fans 21. Pressing the button again disconnects this circuit. Pressing latch and break button 24 engages the circuit electrically connecting to the motors of the fans 21 and the heaters 20. Pressing the button again disconnects this circuit.

In operation the conditioned air apparatus for a baby carriage described herein allows attaching the components of the present invention for conditioned air via fabric ties, by Velcro® fasteners, elastic hooks, snaps, or loops thereby allowing their use when adverse temperature conditions warrant. When weather temperature conditions are favorable the apparatus may simply be detatched, then stored. At assembly the fan housings are first affixed to the inside of the canopy of the stroller, the control module is clamped to the push handle, then the electrical generator hub is placed into contact with the carriage wheel. Consequently, merely pushing buttons allows the caretaker to provide conditioned air in the interior of a baby carriage thereby keeping an infant therein well ventilated and comfortable during a stroll.

If high temperature conditions warrant the user simply inserts a refrigerated cold pack into a compartment before the fan allowing further cooled air to be blown under the canopy of the stroller keeping the infant cool. An optional temperature indicator keeps the caretaker from overheating a cranky child. In fact heating or cooling can be automatically controlled by temperature switching elements. In these respects, the attachable conditioned air components according to the present invention substantially departs from the conventional concepts and designs of the prior art wherein the fans are fixed in position at construction of the baby stroller and the electrical power is supplied by battery.

This invention will enable parents and caretakers to have a baby or small child outside in hot or cold weather and still keep the child cool and comfortable. In use, rotation of the blower fans by the associated motor draws air into the housing through the inlet opening of the respective housing and forces air out of the outer opening of the respective housing into the area enclosed by the canopy to provide air circulation and ventilation to the enclosed area of the canopy and the bassinet.

In view of the foregoing disadvantages inherent in the known types of air conditioned baby carriages and strollers now present in the art, the present invention relies on innovations utilizing reliable circulating conditioned air in the interior of a baby carriage for keeping an infant therein well ventilated and comfortable.

It is therefore an object of the present invention to provide a conditioned air baby stroller apparatus and method having many of the advantages of the baby carriages and strollers mentioned heretofore and novel features not anticipated, rendered obvious, suggested, or even implied by any of the prior art baby carriages and strollers, either alone or in any combination thereof.

With respect to the above description then, it is to be realized that the optimum dimensional relationships for the parts of the invention, to include variations in size, materials, shape, form, function and manner of operation, assembly and use, are deemed readily apparent and obvious to one skilled in the art and all equivalent relationships to those illustrated in the drawings and descriptions in the specification are intended to be encompassed by the present invention.

Therefore, the foregoing is considered as illustrative only of the principles of the invention. Further, since numerous modifications and changes, will readily occur to those skilled in the art, it is not desired to limit the invention to the exact construction and operation shown and described, and accordingly, all suitable modifications and equivalents may be resorted to, falling within the scope of the invention.

I claim:

1. An attachable cooling and heating apparatus for providing conditioned air for a baby in a carriage operable by infant's caretaker comprising, in combination:
a baby carriage having a container for receiving a baby, four wheels secured therebelow, a push handle for pushing the carriage to traverse the ground, and a canopy positioned over one end of the carriage for providing a protective environment for an infant;
a fan assembly attachable to inside of said canopy;
said fan assembly including fan motor, rotatable fan blades, and heater inside a housing and allowing electrical connection to a source of electric power;
a protective screen secured to said fan housing protecting the infant against injury from the fan blades when rotating and heater when activated;
said attachable fan assembly outlet opening directing air flow generated by said blower fan in a path desired by infants caretaker;
said source of electric power an electrical generator attachable to carriage whereby generator is rotatably activated by mechanical engagement with a wheel of said baby carriage;
a control panel switch actuator electrically connected to apparatus and fixedly securable by clamp mechanism to said push handle of baby stroller, wherein
by combination attachable cooling and heating apparatus provides increased comfort for an infant in a baby carriage.

2. The conditioned air apparatus of claim 1, wherein each component of said apparatus is fixably installed at construction of said baby carriage.

3. The conditioned air apparatus of claim 1, wherein multiple fan assemblies may be attached to said baby carriage where desired by caretaker.

4. The conditioned air apparatus of claim 1, wherein said electrical generator contains a voltage regulator.

5. The conditioned air apparatus of claim 1, wherein a battery disposed in a pouch on said bassinet is included and electrically connected to said regulated generator for recharging said battery, thereby providing reliable electric power when baby carriage is not being pushed.

6. The conditioned air apparatus of claim 1, further comprising push button activators on said attachable control panel switch actuator, for activating either cooled or heated air.

7. Said push button activators of said attachable control panel switch actuator of claim 1 of latch and break switch type allowing selected on/off electrical connections to said motors and heaters of said fan assemblies.

8. The conditioned air apparatus of claim 1, wherein additional cooling means is provided consisting of a cold pack of material adapted to be cooled at a remote location and then placed within the housing adjacent to the air inlet opening of said fan assembly for cooling the air flowing into the housing.

9. The baby carriage of claim 1, wherein snap-on cover provides additional microenvironment protection for infant.

10. The conditioned air apparatus of claim 1 wherein temperature sensing and display is added to attachable control panel switch actuator allowing automatic temperature control.
